(19) United States
(12) Patent Application Publication
(10) Pub. No.: US 2023/0371747 A1
(43) Pub. Date: Nov. 23, 2023

(54) Divided Cookware Device

(71) Applicant: Jewell Matthews, Harleysville, PA (US)

(72) Inventor: Jewell Matthews, Harleysville, PA (US)

(21) Appl. No.: 18/314,918

(22) Filed: May 10, 2023

Related U.S. Application Data
(60) Provisional application No. 63/343,685, filed on May 19, 2022.

(51) Int. Cl. A47J 37/10; A47J 36/02; A47J 45/06; A23L 5/10

(52) U.S. Cl. CPC A47J 37/10; A47J 36/025; A47J 45/061; A47J 45/063; A23L 5/10

(57) ABSTRACT

The present invention relates to a divided cookware device. During use, the device separates food during cooking and keeps said food warm after cooking. The device is primarily comprised of a body with at least one divider and at least one handle. The body may be any style of cookware body, wherein the divider wall forms at least one food area within the body. The divider wall is preferably made from the same material as the body, wherein said material conducts heat.

### CROSS-REFERENCE TO RELATED APPLICATION

The present application claims priority to, and the benefit of, U.S. Provisional Application No. 63/343,685, which was filed on May 19, 2022, and is incorporated herein by reference in its entirety.

### FIELD OF THE INVENTION

The present invention relates generally to the field of cookware. More specifically, the present invention relates to a divided cookware device for separating food during cooking and keeping said food warm after cooking. The device has a body with a divider wall, preferably made from the same material as the body, wherein said material conducts heat. Accordingly, the present disclosure makes specific reference thereto. Nonetheless, it is to be appreciated that aspects of the present invention are also equally applicable to other like applications, devices, and methods of manufacture.

### BACKGROUND

Individuals may prefer warming and cooking food on a stovetop rather than in a microwave for a more enjoyable eating experience. This is due to the fact that food heated in a microwave can become soggy and undesirable. However, trying to heat multiple different types of food in the same skillet or pot may be nearly impossible due to the food mixing together, which also may be undesirable. In addition, it is difficult to keep food warm for a prolonged period of time when heating food via a stove.

Therefore, there exists a long-felt need in the art for an improved piece of cookware. More specifically, there exists a long-felt need for a divided cookware device. There also exists a long-felt need in the art for a divided cookware device wherein the device separates food while it is being cooked or heated using the device on a stovetop or in an oven. In addition, there exists a long-felt need in the art for a divided cookware device that keeps food within the body of the device warm for a longer period of time than existing stovetop cookware.

The subject matter disclosed and claimed herein, in one embodiment thereof, comprises a divided cookware device. The device is primarily comprised of a body with at least one divider and at least one handle. The body may be any style of cookware body, wherein the divider wall forms at least one food area within the body. The divider wall is preferably made from the same material as the body, wherein said material conducts heat. An interior surface of the body and any exterior surface of the divider wall may have a non-stick coating. In addition, the device may be comprised of a lid. The body of the device may also have a handle that is made from a non-conductive material.

In this manner, the divided cookware device of the present invention accomplishes all the foregoing objectives and provides an improved piece of cookware. To accomplish this, the device separates food while it is being cooked or heated via the divider wall. In addition, the divider wall keeps food within the body of the device warm for a longer period of time than existing stovetop cookware by adding another point of contact to the food.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a divided cookware device primarily comprised of a body with at least one divider and at least one handle. The body of the device may resemble any type of cookware known in the art. The body is preferably made from a material that conducts heat. Said material may include, but is not limited to, stainless steel, ceramic, copper, aluminum, carbon steel, cast iron, clay, stone, glass, metal, etc.

The interior surface of the body is preferably comprised of a non-stick coating. The coating may be any non-stick coating known in the art. The coating prevents food from sticking to the interior surface when the device is used to cook, serve, and/or store food.

The body may also have at least one handle. The material of the handle preferably does not conduct heat. This prevents the handle from becoming hot during use and burning a user via heat transfer from the handle to a user's hand. In one embodiment, the handle may be comprised of at least one grip made from a non-slip material such as, but not limited to, rubber. The non-slip material prevents the handle from slipping out of a hand of a user during use.

The device may also be comprised of at least one lid. The lid can be placed over the body while using the body to cook food or while storing food. The lid is preferably transparent to allow a user to see the food within the body. The lid may be made from the same material as the body or a different material.

The body further has at least one divider wall that is immovably positioned within and attached to the body. The divider wall is preferably made of the same material as the body such that the divider wall conducts heat in the same manner as the body. The exterior surfaces of the divider wall are preferably covered with a non-stick coating. In one embodiment, the body may have a plurality of divider walls to create a plurality of separated food areas within the body that prevent different types of food from touching while cooking.

The divider walls not only separate different types of food within the body from touching but also helps keep food within each food area warm. This is because the divider wall ensures the food is heated on all sides and bottom (excluding the top of the food when the body is not covered by the lid). This is in contrast to existing cookware known in the art, which only allows food on the outside areas of the body to be heated by the interior surface.

The present invention is also comprised of a method of use. First, a device is provided. The device is primarily comprised of a body with at least one divider wall and at least one handle. Then, at least one food item is placed within at least one food area of the body created by the divider wall and interior surface of the body. Then, the food can be cooked by placing the body on a heat source. After cooking the food, the food can remain in the food area while being kept warm by the interior surface and the exterior surface of the divider wall.

Accordingly, the divided cookware device of the present invention is particularly advantageous as it provides an improved piece of cookware that separates food while it is being cooked or heated via the divider wall. In addition, the divider wall keeps food within the body of the device warm for a longer period of time than existing stovetop cookware by adding another point of contact to the food. In this manner, the divided cookware device overcomes the limitations of existing cookware known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of two potential embodiments of a divided cookware device of the present invention in accordance with the disclosed architecture;

FIG. 2 illustrates a perspective view of two potential embodiments of a divided cookware device of the present invention in accordance with the disclosed architecture;

FIG. 3 illustrates a perspective view of one potential embodiment of a divided cookware device of the present invention while holding food in accordance with the disclosed architecture; and

FIG. 4 illustrates a flowchart of a method of using one potential embodiment of a divided cookware device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved piece of cookware. More specifically, there exists a long-felt need for a divided cookware device. There also exists a long-felt need in the art for a divided cookware device wherein the device separates food while it is being cooked or heated using the device on a stovetop or in an oven. In addition, there exists a long-felt need in the art for a divided cookware device that keeps food within the body of the device warm for a longer period of time than existing stovetop cookware.

The present invention, in one exemplary embodiment, is comprised of a divided cookware device. The device is primarily comprised of a body with at least one divider and at least one handle. The body of the device may resemble any type of cookware known in the art. The body is preferably made from a material that conducts heat, including, but not limited to, stainless steel, ceramic, copper, aluminum, carbon steel, cast iron, clay, stone, glass, metal, etc. The interior surface of the body is preferably comprised of a non-stick coating of any non-stick coating known in the art. The coating prevents food from sticking to the interior surface when the device is used to cook, serve, and/or store food.

The body may also have at least one handle. The material of the handle preferably does not conduct heat. This prevents the handle from becoming hot during use and burning a user via heat transfer from the handle to a user's hand. In one embodiment, the handle may be comprised of at least one grip made from a non-slip material such as, but not limited to, rubber. The non-slip material prevents the handle from slipping out of a hand of a user during use.

The device may also be comprised of at least one lid that can be placed over the body while using the body to cook food or while storing food. The lid is preferably transparent to allow a user to see the food within the body. The lid may be made from the same material as the body or a different material.

The body further has at least one divider wall that is immovably positioned within and attached to the body. The divider wall is preferably made of the same material as the body such that the divider wall conducts heat in the same manner as the body. The exterior surfaces of the divider wall are preferably covered with a non-stick coating. In one embodiment, the body may have a plurality of divider walls to create a plurality of separated food areas within the body that prevent different types of food from touching while cooking.

The divider walls not only separate different types of food within the body from touching but also helps keep food within each food area warm. This is because the divider wall ensures the food is heated on all sides and bottom (excluding the top of the food when the body is not covered by the lid). This is in contrast to existing cookware known in the art, which only allows food on the outside areas of the body to be heated by the interior surface.

The present invention is also comprised of a method of use. First, a device is provided. The device is primarily comprised of a body with at least one divider wall and at least one handle. Then, at least one food item is placed within at least one food area of the body created by the divider wall and interior surface of the body. Then, the food can be cooked by placing the body on a heat source. After cooking the food, the food can remain in the food area while being kept warm by the interior surface and the exterior surface of the divider wall.

Accordingly, the divided cookware device of the present invention is particularly advantageous as it provides an improved piece of cookware that separates food while it is being cooked or heated via the divider wall. In addition, the divider wall keeps food within the body of the device warm for a longer period of time than existing stovetop cookware by adding another point of contact to the food. In this manner, the divided cookware device overcomes the limitations of existing cookware known in the art.

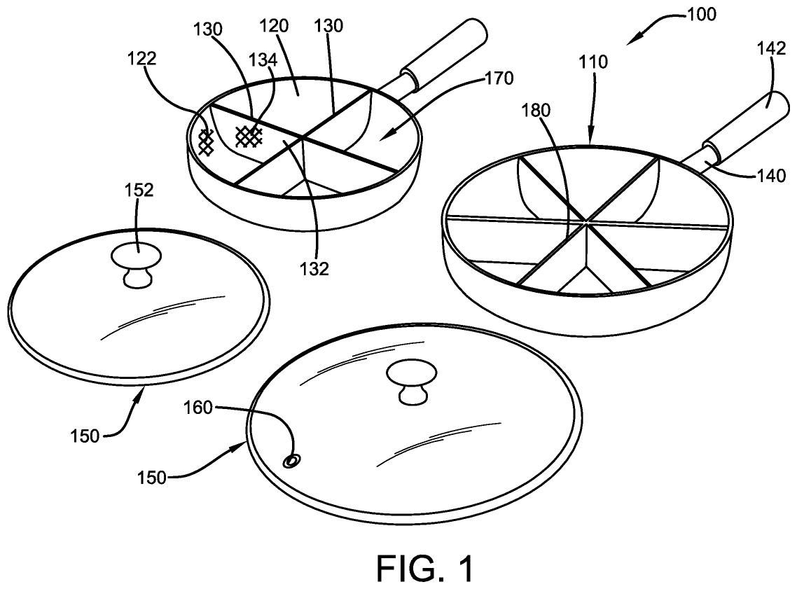

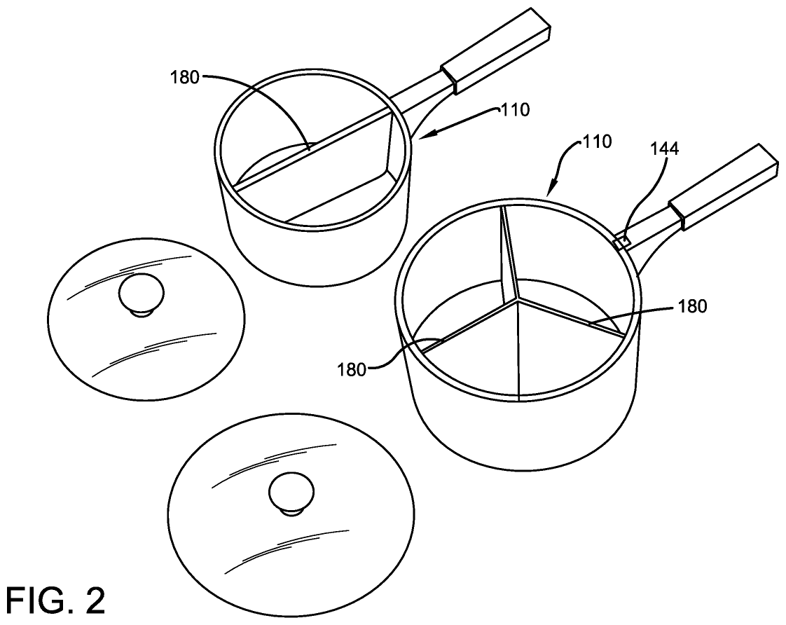

Referring initially to the drawings, FIG. 1 illustrates a perspective view of two potential embodiments of a divided cookware device 100 of the present invention in accordance with the disclosed architecture. The device 100 is primarily comprised of a body 110 with at least one divider 130 and at least one handle 140. The device 100 is intended to be used as cookware. As a result, the body 110 of the device 100 may resemble any type of cookware known in the art. This includes, but is not limited to, a stock pot, a frying pan, a cast iron skillet, a sauté pan, a saucepan, a braiser, a grill pan, a wok, a roasting pan, a crepe pan, a casserole dish, a Dutch oven, etc., as also seen in FIG. 2. The body 110 is preferably made from a material that conducts heat. Said material may include, but is not limited to, stainless steel, ceramic, copper, aluminum, carbon steel, cast iron, clay, stone, glass, metal, etc.

The interior surface 120 of the body 110 is preferably comprised of a non-stick coating 122. The coating 122 may be any non-stick coating known in the art. The coating 122 prevents food 10 from sticking to the interior surface 120 when the device 100 is used to cook, serve, and/or store food 10.

The body 110 may also have at least one handle 140. The handle 140 may be any style of cookware handle known in the art. The handle 140 may be made from the same or a different material than the body 110. The material of the handle 140 preferably does not conduct heat. This prevents the handle 140 from becoming hot during use and burning a user via heat transfer from the handle 140 to a user's hand.

In one embodiment, the handle 140 may be comprised of at least one grip 142. The grip 142 may be made from a non-slip material such as, but not limited to, rubber. The non-slip material prevents the handle 140 from slipping out of a hand of a user during use. The grip 142 may be comprised of a raised or recessed texture to promote grip. The grip 142 is preferably made from a material that does not conduct heat. This prevents the grip 142 from becoming hot during use and burning a user via heat transfer from the grip 142 to a user's hand.

In one embodiment, the handle 140 is immovable and fixedly attached to the body 110. In another embodiment, the handle 140 is attached to the body 110 via at least one hinge 144. The hinge 144 is preferably a locking hinge, but may be any hinge type known in the art. The hinge 144 allows the handle 140 to be folded when not in use to allow the device 100 to be easily stored. When in use, the handle 140 can be unfolded and the hinge 144 can be locked.

The device 100 may also be comprised of at least one lid 150. The lid 150 can be placed over the body 110 while using the body 110 to cook food 10 or while storing food 10. The lid 150 is preferably transparent to allow a user to see the food 10 within the body 110. The lid 150 may be made from the same material as the body 110 or a different material.

The lid 150 may be comprised of at least one handle 152. The handle 152 may be any style of lid handle known in the art. The handle 152 may be made from the same or a different material than the lid 150. The material of the handle 152 preferably does not conduct heat. This prevents the handle 152 from becoming hot during use and burning a user via heat transfer from the handle 152 to a user's hand.

In one embodiment, the handle 152 is made from a non-slip material such as, but not limited, to rubber. The non-slip material prevents the handle 152 from slipping out of a hand of a user during use. The handle 152 may be comprised of a raised or recessed texture to promote grip.

The lid 150 may also have at least one opening 160. The opening 160 allows steam to exit the body 110 while the device 100 is being used to cook with the lid 150 on the body 110. In another embodiment, the lid 150 may have no opening 160.

The body 110 further has at least one divider wall 130. The divider wall 130 is immovably positioned within and attached to the body 110. The divider wall 130 is preferably made of the same material as the body 110 such that the divider wall 130 conducts heat in the same manner as the body 110. The exterior surfaces 132 of the divider wall 130 are preferably covered with a non-stick coating 134. The coating 134 may be any non-stick coating known in the art. In one embodiment, the body 110 may have a plurality of divider walls 130 to create a plurality of separated food areas 170 within the body 110. Said areas 170 prevent different types of food 10 from touching while cooking.

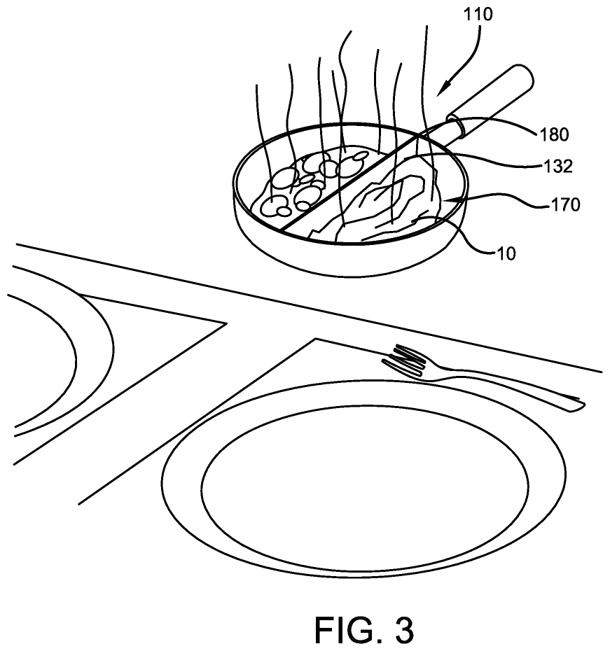

The divider walls 130 not only separate different types of food 10 within the body 110 from touching but also help keep food 10 within each food area 170 warm. This is because the divider wall 130 ensures the food 10 is heated on all sides and bottom (excluding the top of the food 10 when the body 110 is not covered by the lid 150), as seen in FIG. 3. This is in contrast to existing cookware known in the art, which only allows food 10 on the outside areas of the body 110 to be heated by the interior surface 120. As a result, the device 100 can be used to more efficiently cook and heat food 10. In addition, the device 100 allows the food 10 to remain warm longer after cooking has finished.

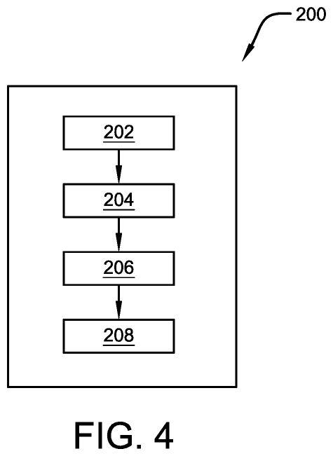

FIG. 4 illustrates a flowchart of a method of using 200 one potential embodiment of a divided cookware device 100 of the present invention in accordance with the disclosed architecture. The present invention is also comprised of a method of use 200. First, a device 100 is provided. The device 100 is primarily comprised of a body 110 with at least one divider wall 130 and at least one handle 140 [Step 202]. Then, at least one food item 10 is placed within at least one food area 170 of the body 110 created by the divider wall 130 and interior surface 120 of the body 110 [Step 204]. Then, the food 10 can be cooked by placing the body 110 on a heat source [Step 206]. After cooking the food 10, the food 10 can remain in the food area 170 while being kept warm by the interior surface 120 and the exterior surface 132 of the divider wall 130 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “divided cookware device” and “device” are interchangeable and refer to the divided cookware device 100 of the present invention.

Notwithstanding the foregoing, the divided cookware device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the divided cookware device 100 as shown in the FIGS. are for illustrative purposes only, and that many other sizes and shapes of the divided cookware device 100 are well within the scope of the present disclosure. Although the dimensions of the divided cookware device 100 are important design parameters for user convenience, the divided cookware device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A divided cookware device comprising:
a body comprised of an interior surface and a divider wall; and
a handle attached to the body.

2. The divided cookware device of claim 1, wherein the body is comprised of a stock pot shape, a frying pan shape, a cast iron skillet shape, a sauté pan shape, a saucepan shape, a grill pan shape, a wok shape, a roasting pan shape, a crepe pan shape, a casserole dish shape, or a Dutch oven shape.

3. The divided cookware device of claim 1, wherein the body is comprised of a heat-conductive material.

4. The divided cookware device of claim 3, wherein the material is comprised of a stainless steel, a ceramic, a copper, an aluminum, a carbon steel, a cast iron, a clay, a stone, a glass, or a metal material.

5. The divided cookware device of claim 1, wherein the interior surface is comprised of a non-stick coating.

6. The divided cookware device of claim 1, wherein an exterior surface of the divider wall is comprised of a non-stick coating.

7. The divided cookware device of claim 1, wherein the divider wall and the body form a food area.

8. A divided cookware device comprising:
a body comprised of an interior surface and a divider wall;
a first handle attached to the body via a hinge; and
a lid comprised of a second handle.

9. The divided cookware device of claim 8, wherein the handle is comprised of a non-conductive material.

10. The divided cookware device of claim 8, wherein the hinge is comprised of a locking hinge.

11. The divided cookware device of claim 8, wherein the handle is comprised of a grip.

12. The divided cookware device of claim 11, wherein the grip is comprised of a non-conductive material.

13. The divided cookware device of claim 11, wherein the grip is comprised of a non-slip material.

14. The divided cookware device of claim 8, wherein the lid is comprised of a transparent lid.

15. The divided cookware device of claim 8, wherein the lid is comprised of an opening.

16. The divided cookware device of claim 8, wherein the second handle is comprised of a non-conductive material.

17. The divided cookware device of claim 8, wherein the second handle is comprised of a non-slip material.

18. The divided cookware device of claim 8, wherein the first handle is comprised of a texture.

19. The divided cookware device of claim 8, wherein the second handle is comprised of a texture.

20. A method of cooking a food item, the method comprising the steps of:
providing a divided cookware device comprised of a body, a divider wall, a food area, and a handle;
placing the food item into the food area of the divided cookware device;
cooking the food item by placing the divided cookware device on a heat source; and
storing the food item within the food area after it has been cooked.
